(19) United States
(12) Patent Application Publication
(10) Pub. No.: US 2026/0178251 A1
(43) Pub. Date: Jun. 25, 2026

(54) INFORMATION PROCESSING SYSTEM, IMAGE PROCESSING SYSTEM, AND INFORMATION PROCESSING METHOD

(71) Applicant: KYOCERA Document Solutions Inc., Osaka-shi (JP)

(72) Inventor: Shunsuke Sasaki, Osaka (JP)

(21) Appl. No.: 19/412,611

(22) Filed: Dec. 8, 2025

(30) Foreign Application Priority Data
Dec. 19, 2024 (JP) 2024-223898

(51) Int. Cl. G06F 3/12

(52) U.S. Cl. CPC G06F 3/1253; G06F 3/1205

(57) ABSTRACT

An information processing system includes an acquisition portion and a display control portion. The acquisition portion communicates with an image processing system capable of executing image forming processing for forming an image on a sheet based on image data to acquire function information indicating a function of the image processing system. The display control portion causes, based on the function information, a display portion to display a setting screen including a first setting item relating to a job executable by the image processing system and restricting display of a second setting item relating to a job not executable by the image processing system.

### INCORPORATION BY REFERENCE

This application is based upon and claims the benefit of priority from the corresponding Japanese Patent Application No. 2024-223898 filed on Dec. 19, 2024, the entire contents of which are incorporated herein by reference.

The present disclosure relates to an information processing system, an image processing system, and an information processing method.

### BACKGROUND

As a related art, an information processing apparatus that identifies the source of a request for setting of printing performed by a printing device has been known. When it is determined that a predetermined application is the source of the request, the information processing apparatus controls display of a print setting screen based on setting information indicating print function conditions that can be set in accordance with the source of the request.

### SUMMARY

A information processing system according to one aspect of the present disclosure includes an acquisition portion and a display control portion. The acquisition portion communicates with an image processing system capable of executing image forming processing for forming an image on a sheet based on image data to acquire function information indicating a function of the image processing system. The display control portion causes, based on the function information, a display portion to display a setting screen including a first setting item relating to a job executable by the image processing system and restricting display of a second setting item relating to a job not executable by the image processing system.

An image processing system according to another aspect of the present disclosure includes a reception processing portion and a transmission processing portion. The reception processing portion communicates with the information processing system to receive a transmission request for the function information from the information processing system. The transmission processing portion transmits the function information to the information processing system.

An information processing method according to another aspect of the present disclosure is an information processing method executed by one or more processors, and includes: communicating with an image processing system capable of executing image forming processing for forming an image on a sheet based on image data to acquire function information indicating a function of the image processing system; and causing, based on the function information, a display portion to display a setting screen including a first setting item relating to a job executable by the image processing system and restricting display of a second setting item relating to a job not executable by the image processing system.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a front view of an image processing system according to an embodiment.

FIG. 2 is a block diagram showing a configuration of the image processing system according to the embodiment.

FIG. 3 is a schematic view showing configurations of an image forming apparatus and a relay conveying apparatus in the image processing system according to the embodiment.

FIG. 4 is a schematic view showing a configuration of a post-processing apparatus in the image processing system according to the embodiment.

FIG. 5 is a block diagram showing a configuration of an information processing system according to the embodiment.

FIG. 6 shows an example of a setting screen in first display control processing of the information processing system according to the embodiment.

FIG. 7 shows another example of the setting screen in the first display control processing of the information processing system according to the embodiment.

FIG. 8 is a sequence diagram showing the first display control processing of the information processing system according to the embodiment.

FIG. 9 shows an example of a setting screen in second display control processing of the information processing system according to the embodiment.

FIG. 10 shows another example of the setting screen in the second display control processing of the information processing system according to the embodiment.

FIG. 11 is a flowchart showing the second display control processing of the information processing system according to the embodiment.

### DETAILED DESCRIPTION

Hereinafter, an embodiment of the present disclosure will be described with reference to the accompanying drawings. The following embodiment is an example of embodying the present disclosure and is not intended to limit the technical scope of the present disclosure.

### Configuration of Image Processing System 200

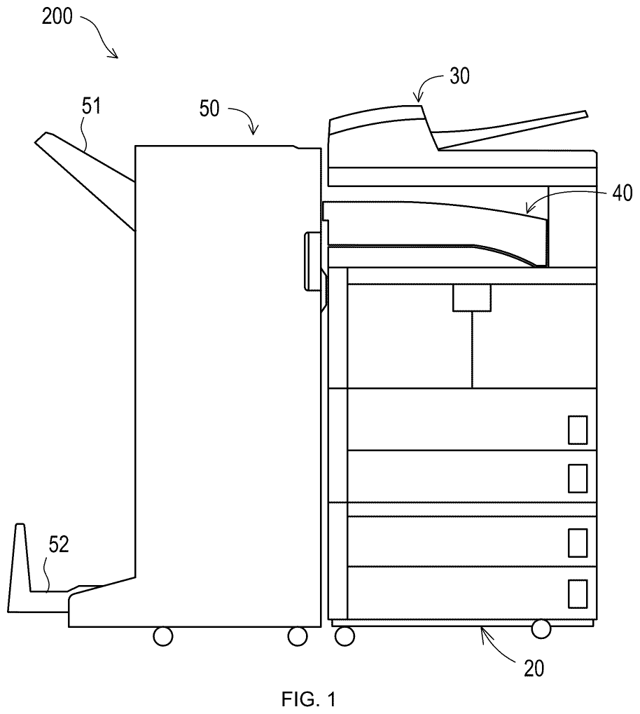

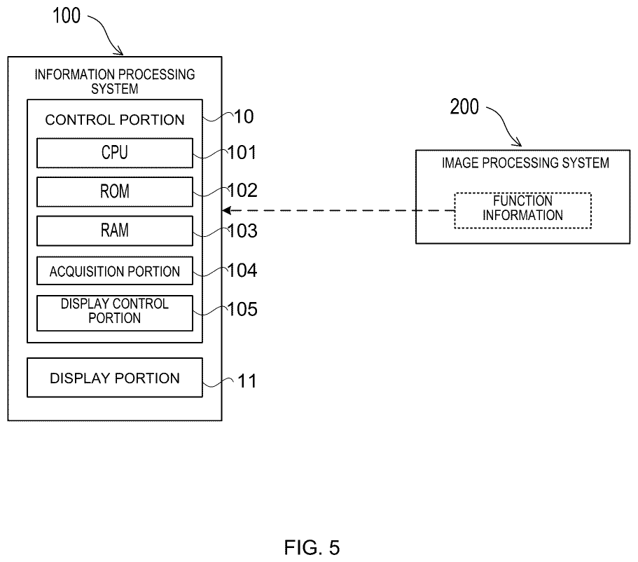

First, an image processing system 200 electrically connected to an information processing system 100 (see FIG. 5) according to the present embodiment will be described with reference to FIG. 1 to FIG. 4. Here, the information processing system 100 is, for example, a smartphone, a tablet terminal, or a personal computer. By being electrically connected to the image processing system 200, the information processing system 100 can transmit, to the image processing system 200, an execution instruction for a job, such as print processing, executed by the image processing system 200.

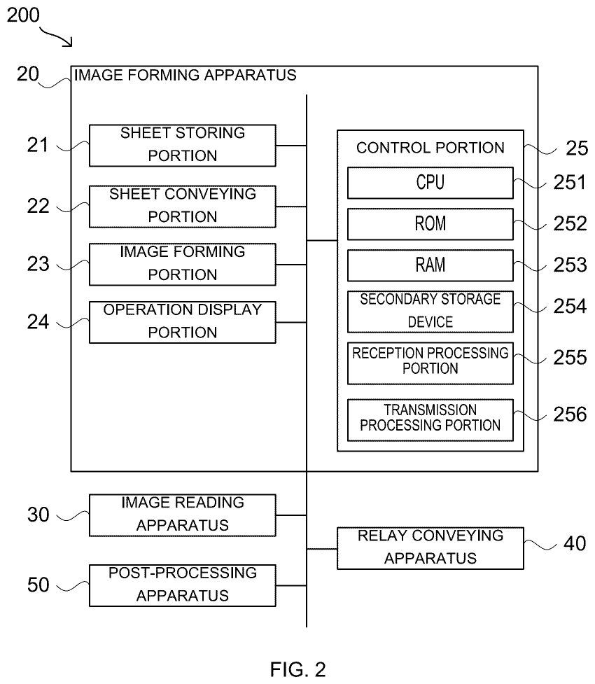

As shown in FIG. 1 and FIG. 2, the image processing system 200 according to the present embodiment includes an image forming apparatus 20, an image reading apparatus 30, a relay conveying apparatus 40, a post-processing apparatus 50, and the like. The image processing system 200 according to the present embodiment is a multifunction peripheral system having a plurality of functions, such as a printer, a copier, a scanner, or a facsimile machine.

For example, in the image processing system 200, the image reading apparatus 30 reads image data, and the image forming apparatus 20 executes copying processing or the like for forming an image on a sheet Sh1 based on the image data. The sheet Sh1 after image formation is conveyed to the post-processing apparatus 50 via the relay conveying apparatus 40. In the post-processing apparatus 50, post-processing such as a binding process or a folding process is performed on the sheet Sh1, and the sheet Sh1 is discharged to a discharge tray 51 or a discharge tray 52 of the post-processing apparatus 50.

### Configuration of Image Forming Apparatus 20

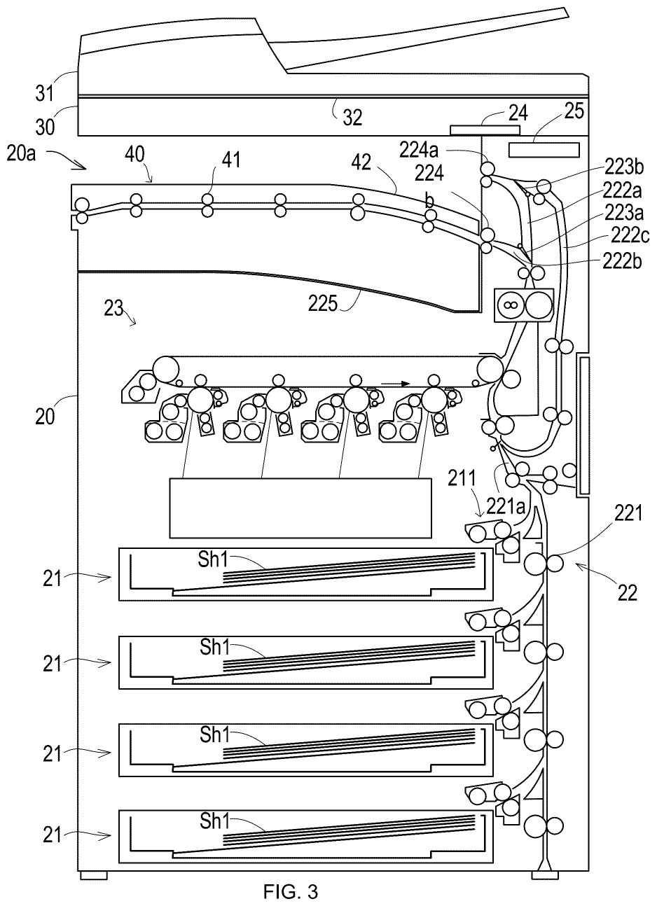

As shown in FIG. 2 and FIG. 3, the image forming apparatus 20 includes a sheet storing portion 21, a sheet conveying portion 22, an image forming portion 23, an operation display portion 24, a control portion 25, and the like.

The sheet storing portion 21 can store a plurality of sheets Sh1. The sheet Sh1 stored in the sheet storing portion 21 is supplied to the sheet conveying portion 22 by a sheet feed portion 211 provided in each sheet storing portion 21. The sheet Sh1 is a sheet-like image forming medium such as paper or a resin film.

The sheet conveying portion 22 includes a plurality of conveying rollers 221, and conveys the sheet Sh1 supplied from the sheet storing portion 21 toward an internal discharge portion 20a by the conveying rollers 221. Specifically, the sheet conveying portion 22 is provided with a conveying path 221a, conveying paths 222a to 222c, and the like along which the sheet Sh1 is conveyed. In addition, the sheet conveying portion 22 is also provided with switching portions 223a and 223b for switching the conveying destination of the sheet Sh1 conveyed along the conveying path 221a. Both the switching portions 223a and 223b are driven by a drive source (not shown) such as a solenoid. The drive source is controlled by the control portion 25.

On the conveying path 221a, the sheet Sh1 supplied from the sheet storing portion 21 is conveyed toward the image forming portion 23. On the conveying path 222a, the sheet Sh1 after image formation by the image forming portion 23 is conveyed toward a discharge roller 224a, and the sheet Sh1 is discharged to the internal discharge portion 20a by the discharge roller 224a. On the conveying path 222b, the sheet Sh1 after image formation by the image forming portion 23 is conveyed toward a discharge roller 224b, and the sheet Sh1 is discharged to the internal discharge portion 20a by the discharge roller 224b. The conveying path 222c is used for conveying the sheet Sh1, which has had an image formed on one surface by the image forming portion 23 and has been conveyed to the discharge roller 224b, to the image forming portion 23 again. It is noted that the sheet Sh1 conveyed again to the image forming portion 23 via the conveying path 222c is in a state where its front and back surfaces are reversed compared to when the sheet Sh1 was initially conveyed to the image forming portion 23 and had an image formed on one surface. Thus, the image forming portion 23 can form an image on the other surface of the sheet Sh1 conveyed again to the image forming portion 23 via the conveying path 222c.

The image forming portion 23 executes print processing for forming an image based on image data to be printed on the sheet Sh1 conveyed by the sheet conveying portion 22. Specifically, the image forming portion 23 includes a photoconductor drum, a charging roller, a laser scanning unit, a developing device, a transfer roller, a cleaning device, a fixing device, and the like, and forms an image using an electrophotographic method. For example, in the print processing, the image forming portion 23 forms an image on the sheet Sh1 based on image data read by the image reading apparatus 30 or image data received from an external computer or the like. It is noted that the image forming portion 23 may form an image using another image forming method such as an inkjet method.

The operation display portion 24 is a user interface of the image processing system 200. The operation display portion 24 includes a display portion such as a liquid crystal display that displays various types of information in response to control instructions from the control portion 25, and an operation portion such as operation keys or a touch panel that inputs various types of information to the control portion 25 in response to user operations.

The control portion 25 is a computer that performs overall control of the image processing system 200 including the image forming apparatus 20, the post-processing apparatus 50, and the like. Therefore, in the image processing system 200, the image reading apparatus 30, the relay conveying apparatus 40, and the post-processing apparatus 50 connected to the image forming apparatus 20 are electrically connected to the control portion 25. The control portion 25 controls the operations of the image reading apparatus 30, the relay conveying apparatus 40, and the post-processing apparatus 50.

The control portion 25 includes a central processing unit (CPU) 251, a read only memory (ROM) 252, a random access memory (RAM) 253, and a secondary storage device 254. The CPU 251 is one or more processors that execute various types of arithmetic processing. The ROM 252 is a nonvolatile storage device in which information such as control programs for causing the CPU 251 to execute various types of processing are stored in advance. The RAM 253 is a volatile or nonvolatile storage device used as a temporary storage memory (work area) for various types of processing executed by the CPU 251. Information such as control programs for causing the CPU 251 to execute various types of processing is stored in advance in the secondary storage device 254. The secondary storage device 254 is a computer-readable non-volatile storage device such as a flash memory or a hard disk drive. In addition, the control portion 25 can also record various types of data in the secondary storage device 254, update the control programs, and the like.

In addition, the control portion 25 includes various processing portions such as a reception processing portion 255 and a transmission processing portion 256. In other words, the image processing system 200 includes the reception processing portion 255 and the transmission processing portion 256. Specifically, the secondary storage device 254 of the control portion 25 stores in advance control programs for causing the CPU 251 to function as the processing portions described above. By executing the control programs stored in the secondary storage device 254, the CPU 251 functions as the processing portions described above. It is noted that the processing portions described above may be constituted by an electronic circuit.

The reception processing portion 255 receives a transmission request for function information (to be described later) from the information processing system 100 by communicating with the information processing system 100. Specifically, the reception processing portion 255 receives the transmission request by communicating with the information processing system 100 via, for example, a wired local area network (LAN), a wireless LAN, or the like.

The transmission processing portion 256 transmits the function information to the information processing system 100. Specifically, when the reception processing portion 255 receives the transmission request, the transmission processing portion 256 reads the function information stored in the ROM 252 or the secondary storage device 254 in advance. The transmission processing portion 256 then transmits the read function information to the information processing system 100 via a wired LAN, a wireless LAN, or the like.

### Configuration of Image Reading Apparatus 30

As shown in FIG. 3, the image reading apparatus 30 includes an automatic document feeder 31, a contact glass 32, and the like. In addition, the image reading apparatus 30 includes a reading unit, a mirror, an optical lens, a charge coupled device (CCD), and the like. The image reading apparatus 30 is controlled by the control portion 25 to execute image reading processing for reading image data from a document sheet set on the automatic document feeder 31 or a document sheet placed on the contact glass 32. The automatic document feeder 31 is openable and closable with respect to the contact glass 32 of the image reading apparatus 30. In the automatic document feeder 31, each of the conveying rollers (not shown) is rotated by receiving rotational drive power supplied from a drive motor (not shown). Accordingly, the document sheet set on the automatic document feeder 31 is fed along a document sheet conveying path in the automatic document feeder 31 via a reading position on the contact glass 32.

### Configuration of Relay Conveying Apparatus 40

As shown in FIG. 1 and FIG. 3, the relay conveying apparatus 40 is mounted in the internal discharge portion 20a of the image forming apparatus 20. The relay conveying apparatus 40 is controlled by the control portion 25 to execute a relay conveying operation for relaying the conveyance of the sheet Sh1 between the image forming apparatus 20 and the post-processing apparatus 50. Specifically, the relay conveying apparatus 40 includes a plurality of conveying rollers 41 that convey the sheet Sh1 after image formation, which is discharged from the conveying path 222b by the discharge roller 224b of the image forming apparatus 20, toward the post-processing apparatus 50. It is noted that the upper surface 42 of the relay conveying apparatus 40 is used as a discharge tray on which the sheet Sh1 after image formation, which is discharged from the conveying path 222a to the internal discharge portion 20a by the discharge roller 224a of the image forming apparatus 20, is placed. In addition, in another embodiment, the image processing system 200 may be configured not to include the relay conveying apparatus 40 and to be capable of directly conveying the sheet Sh1 from the image forming apparatus 20 to the post-processing apparatus 50.

### Configuration of Post-Processing Apparatus 50

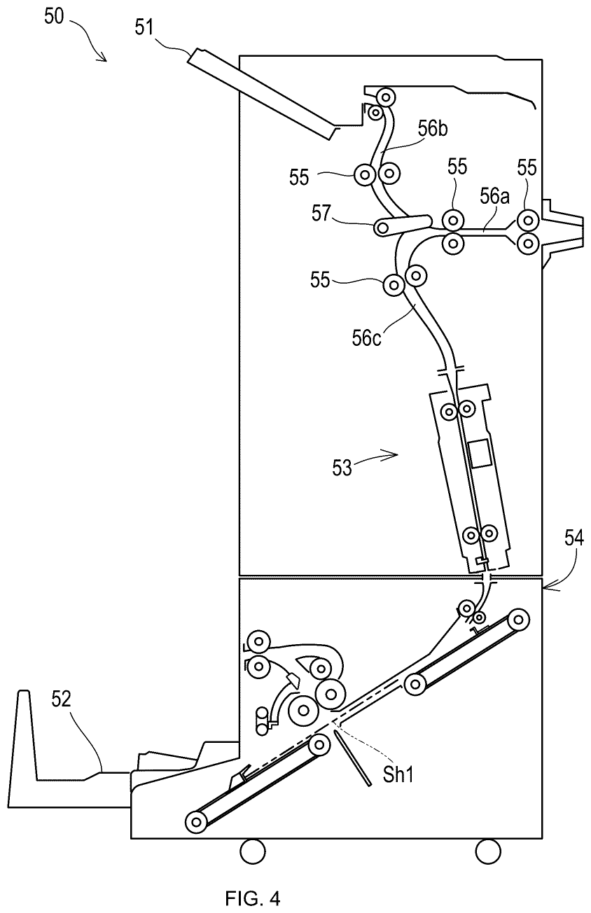

The post-processing apparatus 50 performs post-processing such as a binding process or a folding process, which is set in accordance with a user operation, on the sheet Sh1 supplied from the image forming apparatus 20 via the relay conveying apparatus 40. In particular, as shown in FIG. 4, the post-processing apparatus 50 includes a stapling device 53 that executes a binding process of binding a plurality of sheets Sh1, and a sheet folding device 54 that executes a folding process of applying one or more folds to each of one or more sheets Sh1. It is noted that the post-processing apparatus 50 may be configured to be able to perform a punching process of forming a hole in the sheet Sh1. In addition, the post-processing apparatus 50 may be configured to be able to execute other post-processing such as a sorting process of selectively discharging the sheet Sh1 to a plurality of discharge trays.

The post-processing apparatus 50 is provided with a plurality of conveying rollers 55 that convey the sheet Sh1 supplied to the post-processing apparatus 50, conveying paths 56a to 56c along which the sheet Sh1 is conveyed, and a switching portion 57 that switches the conveying destination of the sheet Sh1 conveyed by the conveying rollers 55. The post-processing apparatus 50 is controlled by the control portion 25 to perform a binding process or a folding process on the sheet Sh1 and then discharge the sheet Sh1 to the discharge tray 51 or the discharge tray 52.

Specifically, in the post-processing apparatus 50, the switching portion 57 is controlled so as to establish communication between the conveying path 56a and the conveying path 56b, whereby the sheet Sh1 is discharged to the discharge tray 51 via the conveying paths 56a and 56b. In addition, in the post-processing apparatus 50, the switching portion 57 is controlled to establish communication between the conveying path 56a and the conveying path 56c, whereby the sheet Sh1 is conveyed toward the stapling device 53 or the sheet folding device 54 via the conveying paths 56a and 56c. Then, the stapling device 53 performs a binding process on the sheet Sh1, and the sheet folding device 54 performs a folding process on the sheet Sh1. It is noted that, in the sheet folding device 54, the folding process can be performed on one sheet Sh1 which is not bound by the stapling device 53, but the folding process can also be performed on a bundle of sheets Sh1 bound by the stapling device 53. Thereafter, the sheet Sh1 subjected to the post-processing by the stapling device 53 or the sheet folding device 54 is discharged to the discharge tray 52. It is noted that the stapling device 53, the sheet folding device 54, and the like provided in the post-processing apparatus 50 are well-known techniques disclosed in, for example, Japanese Unexamined Patent Application Publication No. 2019-73356, and detailed description thereof will be omitted here.

By the way, an image processing system including an image forming apparatus may be electrically connected to an information processing system such as a smartphone or a personal computer. The image processing system may have a function of receiving an instruction to execute a job such as print processing from the information processing system and executing the job. In this case, a setting screen for setting the job details is displayed on the display portion of the information processing system. The user performs input to set the job details while viewing the setting screen, and performs input to transmit an instruction to execute the set job to the image processing system. Thus, the image processing system executes the job in accordance with the received instruction to execute the job.

A general-purpose setting screen may be used for the above-described setting screen so as to be compatible with any of a plurality of types of image processing systems. When such a general-purpose setting screen is used, the user can set setting items relating to jobs not executable by the image processing system. For example, even when the image processing system does not include a post-processing apparatus capable of executing post-processing such as a folding process, the user can set setting items relating to the post-processing.

However, when the user sets a setting item relating to a job not executable by the image processing system, the image processing system cannot execute the job even when an instruction to execute the job is transmitted to the image processing system. Therefore, the user only becomes aware that the job cannot be executed by the image processing system after transmitting the instruction to execute the job. Therefore, the user has to set again a job executable by the image processing system, which causes a problem of unnecessary time and effort.

On the other hand, in the present embodiment, by the processing executed by the information processing system 100 to be described below, the information processing system 100 and information processing method capable of preventing transmission of an instruction to execute a job not executable by the image processing system 200 can be realized.

### Configuration of Information Processing System 100

As shown in FIG. 5, the information processing system 100 includes a control portion 10 and a display portion 11. The control portion 10 is a computer that performs overall control of the information processing system 100, and includes a CPU 101, a ROM 102, and a RAM 103. The CPU 101 is one or more processors that execute various types of arithmetic processing. The ROM 102 is a nonvolatile storage device in which information such as control programs for causing the CPU 101 to execute various types of processing are stored in advance. The RAM 103 is a volatile or nonvolatile storage device used as a temporary storage memory (work area) for various types of processing executed by the CPU 101. It is noted that the control portion 10 may further include a computer-readable non-volatile secondary storage device such as a flash memory or a hard disk drive.

The display portion 11 is a user interface of the information processing system 100. The display portion 11 is composed of, for example, a liquid crystal display that displays various types of information in response to control instructions from the control portion 10. It is noted that, when the information processing system 100 is a mobile terminal such as a smartphone or a tablet terminal, the display portion 11 may further include operation keys or a touch panel for inputting various types of information to the control portion 10 in accordance with user operations. In addition, the operation keys may be provided separately from the display portion 11.

In addition, the control portion 10 includes various processing portions such as an acquisition portion 104 and a display control portion 105. In other words, the information processing system 100 includes an acquisition portion 104 and a display control portion 105. Specifically, the ROM 102 of the control portion 10 stores in advance control programs for causing the CPU 101 to function as the processing portions described above. By executing the control programs stored in the ROM 102, the CPU 101 functions as the processing portions described above. It is noted that the processing portions described above may be constituted by an electronic circuit.

The acquisition portion 104 acquires function information indicating the functions of the image processing system 200 by communicating with the image processing system 200 capable of executing the image forming processing for forming an image on the sheet Sh1 based on image data. Specifically, the acquisition portion 104 requests transmission of the function information by communicating with the image processing system 200 via, for example, a wired LAN or a wireless LAN. Upon receiving the request, the image processing system 200 reads the function information stored in advance in the ROM 252 or the secondary storage device 254, and transmits the read function information to the information processing system 100. Thus, the acquisition portion 104 can acquire the function information from the image processing system 200.

Here, the function information may include, for example, information indicating whether only the monochrome print processing can be executed or both the monochrome print processing and the color print processing can be executed, or information indicating whether the automatic document feeder 31 (feeder) is provided. In addition, the function information may include, for example, information indicating whether only single-sided print processing is possible or both single-sided print processing and double-sided print processing are possible, information indicating whether the post-processing apparatus 50 is provided, or information indicating the number of discharge trays 51, 52. In addition, the function information may include, for example, a range of printable resolutions (dot density) for the sheet Sh1, or the sizes or types of the sheet Sh1 that can be handled. Here, the type of the sheet Sh1 refers to, for example, a type in a case where the sheet Sh1 is paper such as plain paper, inkjet paper, or glossy paper, or a type in a case where the sheet Sh1 is a material other than paper such as fabric or cloth.

In the present embodiment, the function information is provided to the information processing system 100 as an XML schema definition (XSD) file. The XSD file is a framework document that defines the rules or constraints of an extensible markup language (XML) document and formally describes the elements in the XML document. It is noted that the function information is not limited to the XSD file and only has to be provided to the information processing system 100 as a file in a format that can be analyzed by the information processing system 100.

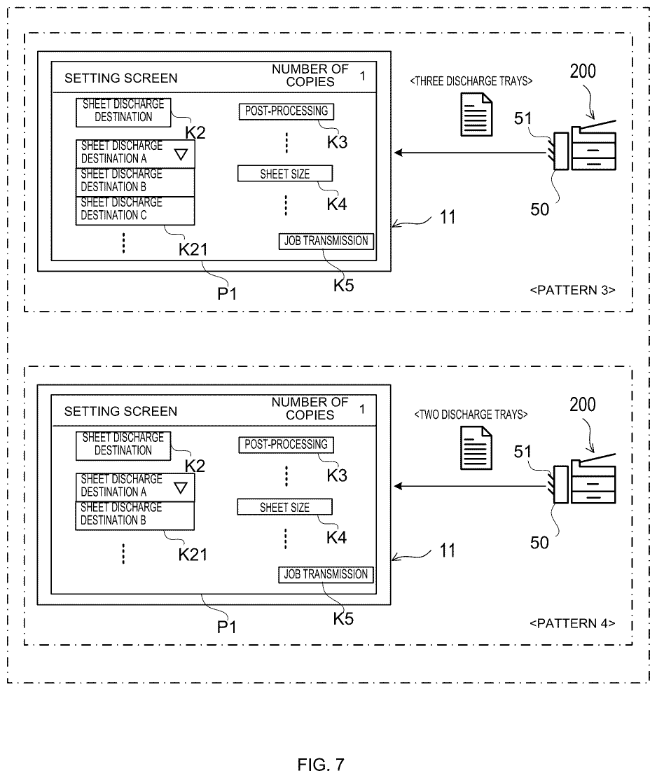

The display control portion 105 causes the display portion 11 to display a setting screen P1 (see FIG. 7, etc.) based on the function information acquired by the acquisition portion 104. Here, the setting screen P1 is a screen for the user to set a job to be executed by the image processing system 200. The setting screen P1 includes setting items for performing various settings such as sheet size, color/monochrome, enlargement/reduction, double-sided printing, page aggregation, and post-processing. In the present embodiment, the setting screen P1 includes first setting items relating to jobs executable in the image processing system 200. On the setting screen P1, the display of second setting items relating to jobs not executable by the image processing system 200 is restricted. In other words, the display control portion 105 executes display control processing for causing the display portion 11 to display the setting screen P1 including first setting items and restricting the display of second setting items. Hereinafter, the display control processing will be referred to as “first display control processing”.

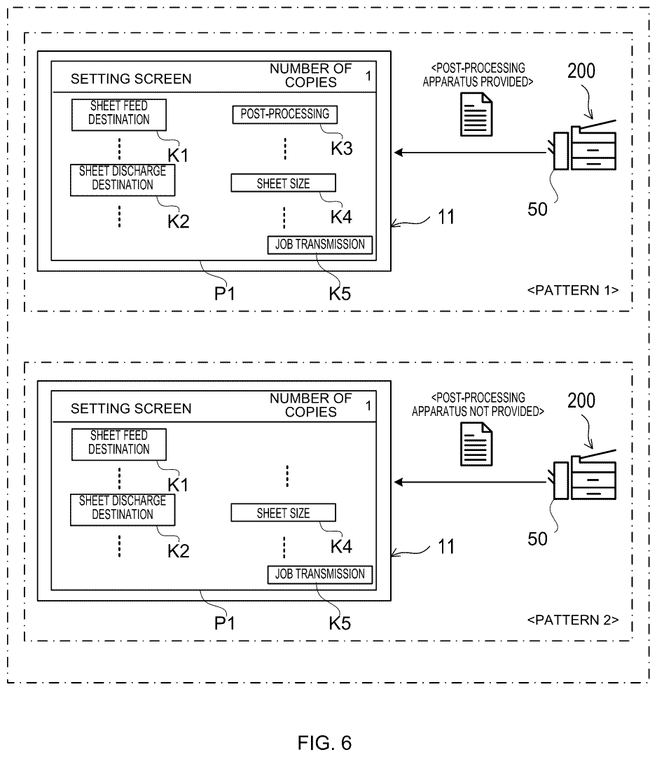

Hereinafter, a specific example of the first display control processing will be described with reference to FIG. 6. The image processing system 200 shown in <Pattern 1> of FIG. 6 includes the post-processing apparatus 50. Therefore, the image processing system 200 transmits function information indicating that the post-processing apparatus 50 is provided to the information processing system 100. On the other hand, the image processing system 200 shown in <Pattern 2> of FIG. 6 does not include the post-processing apparatus 50. Therefore, the image processing system 200 transmits function information indicating that the post-processing apparatus 50 is not provided to the information processing system 100. Here, it is assumed that the image processing system 200 shown in <Pattern 1> and the image processing system 200 shown in <Pattern 2> have the same functions except for the presence or absence of the post-processing apparatus 50.

In <Pattern 1> of FIG. 6, the display control portion 105 causes the display portion 11 to display the setting screen P1 including an operation key K3 of “post-processing” based on the function information acquired by the acquisition portion 104. Specifically, the setting screen P1 displays an operation key K1 of “sheet feed destination” for receiving settings for the sheet feed destination of the sheet Sh1 and an operation key K2 of “sheet discharge destination” for receiving settings for the sheet discharge destination of the sheet Sh1 after image formation. The setting screen P1 also displays an operation key K3 of “post-processing” for receiving settings such as the type of post-processing to be executed on the sheet Sh1 after image formation, and an operation key K4 of “sheet size” for receiving settings for the size of the sheet Sh1. Further, the setting screen P1 shows an operation key K5 of “job transmission” for receiving an instruction to execute a job under the conditions set through the operation keys. Here, the job is print processing for forming an image on the sheet Sh1 based on image data stored in a storage portion such as the secondary storage device 154.

In <Pattern 1> of FIG. 6, “sheet feed destination”, “sheet discharge destination”, “post-processing”, and “sheet size” are all setting items relating to jobs executable in the image processing system 200, and therefore correspond to first setting items. That is, in <Pattern 1> of FIG. 6, the display control portion 105 does not cause the display portion 11 to display the setting screen P1 restricting the display of second setting items.

On the other hand, in <Pattern 2> of FIG. 6, the display control portion 105 causes the display portion 11 to display the setting screen P1 restricting the display of the operation key K3 of “post-processing” based on the function information acquired by the acquisition portion 104. Specifically, the setting screen P1 displays the operation key K1 of “sheet feed destination”, the operation key K2 of “sheet discharge destination”, the operation key K4 of “sheet size”, and the operation key K5 of “job transmission”, but does not display the operation key K3 of “post-processing”.

In <Pattern 2> of FIG. 6, the “sheet feed destination”, the “sheet discharge destination”, and the “sheet size” are all setting items relating to jobs executable by the image processing system 200, and therefore correspond to first setting items. On the other hand, the “post-processing” corresponds to the post-processing apparatus 50 which is not provided in the image processing system 200, and corresponds to a second setting item because it is a setting item relating to jobs not executable by the image processing system 200. That is, in <Pattern 2> of FIG. 6, the display control portion 105 causes the display portion 11 to display the setting screen P1 restricting the display of second setting items.

Next, another specific example of the first display control processing will be described with reference to FIG. 7. The image processing system 200 shown in <Pattern 3> of FIG. 7 includes three discharge trays 51. Therefore, the image processing system 200 transmits function information indicating that three discharge trays 51 are provided to the information processing system 100. On the other hand, the image processing system 200 shown in <Pattern 4> of FIG. 7 includes two discharge trays 51. Therefore, the image processing system 200 transmits function information indicating that two discharge trays 51 are provided to the information processing system 100. Here, it is assumed that the image processing system 200 shown in <Pattern 3> and the image processing system 200 shown in <Pattern 4> have the same functions except for the number of discharge trays 51.

In Pattern 3 of FIG. 7, the display control portion 105 causes the display portion 11 to display the setting screen P1 including “sheet discharge destination A”, “sheet discharge destination B”, and “sheet discharge destination C” as options K21 of “sheet discharge destination” based on the function information acquired by the acquisition portion 104. Here, the “sheet discharge destination A”, “sheet discharge destination B”, and “sheet discharge destination C” correspond to the three discharge trays 51, respectively. In <Pattern 3> of FIG. 7, the “sheet discharge destination A”, the “sheet discharge destination B”, and the “sheet discharge destination C” in the options K21 of the “sheet discharge destination” are all setting items relating to jobs executable in the image processing system 200, and therefore correspond to first setting items. That is, in <Pattern 3> of FIG. 7, the display control portion 105 does not cause the display portion 11 to display the setting screen P1 restricting the display of second setting items.

On the other hand, in <Pattern 4> of FIG. 7, the display control portion 105 causes the display portion 11 to display the setting screen P1 restricting the display of the options K21 of “sheet discharge destination” based on the function information acquired by the acquisition portion 104. Specifically, the setting screen P1 displays, in the options K21 of “sheet discharge destination”, “sheet discharge destination A” and “sheet discharge destination B”, but does not display “sheet discharge destination C”. In <Pattern 4> of FIG. 7, the “sheet discharge destination A” and the “sheet discharge destination B” in the options K21 of “sheet discharge destination” are both setting items relating to jobs executable by the image processing system 200, and thus correspond to first setting items. On the other hand, the “sheet discharge destination C” in the options K21 of “sheet discharge destination” corresponds to the discharge tray 51 which is not provided in the image processing system 200, and corresponds to a second setting item because it is a setting item relating to jobs not executable by the image processing system 200. That is, in <Pattern 2> of FIG. 6, the display control portion 105 causes the display portion 11 to display the setting screen P1 restricting the display of second setting items.

It is noted that, in the examples shown in FIG. 6 and FIG. 7, the display control portion 105 restricts the display of second setting items (here, “post-processing” or “sheet discharge destination C”) by preventing the setting screen P1 from displaying the second setting items, but the present invention is not limited thereto. For example, the display control portion 105 may restrict the display of second setting items by causing the setting screen P1 to display the second setting items in a grayed-out state. In this case, the user can recognize the existence of the second setting items, but cannot cause the image processing system 200 to execute the jobs using the second setting items because the user cannot set the second setting items. Accordingly, the second setting items need only be displayed in a restricted manner on the setting screen P1 such that the user cannot set the second setting items.

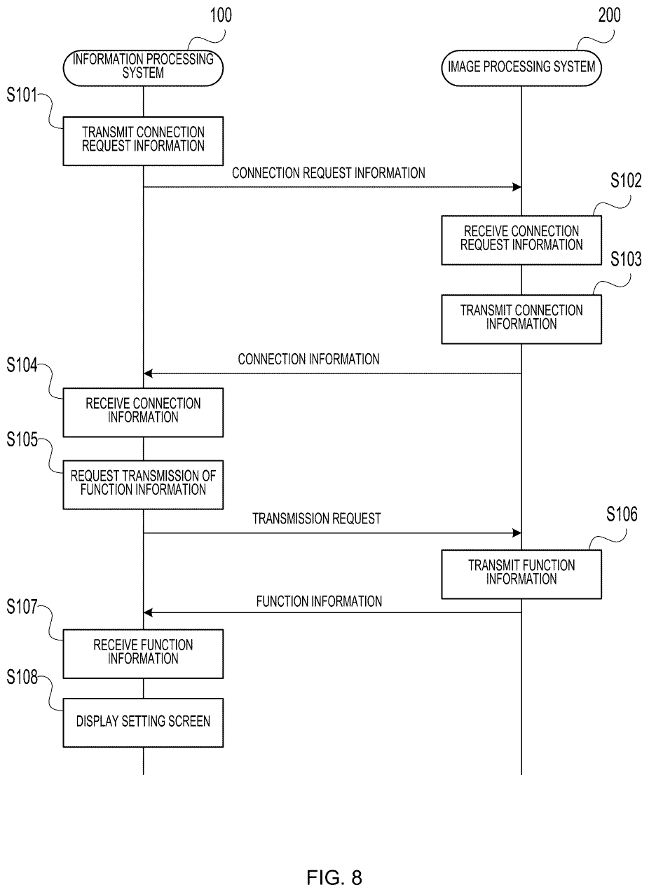

Hereinafter, an example of the information processing method of the present embodiment will be described with reference to FIG. 8, together with an example of a procedure of the first display control processing executed by the information processing system 100. Here, steps S101, S102, . . . represent the numbers of the processing procedure (steps) executed by the information processing system 100 or the image processing system 200. This processing is started, for example, when the user operates the operation key K6 on the setting screen P1 to input an instruction to display a preview image. It is noted that this processing is executed, for example, when the information processing system 100 is electrically connected to the image processing system 200.

### <Step S101>

First, the control portion 10 of the information processing system 100 transmits connection request information for requesting an electrical connection to the image processing system 200 to be connected. The connection request information includes, for example, information designating an Internet protocol (IP) address and a host name of the image processing system 200 to be connected.

### <Step S102>

The control portion 25 of the image processing system 200 receives the connection request information from the information processing system 100. Then, the control portion 25 determines whether or not the connection request information is valid, that is, whether or not the IP address and the host name are correct. Here, the control portion 25 determines that the information is valid, and executes step S103. It is noted that, when the control portion 25 determines that the information is not valid, the control portion 25 transmits information indicating a communication error to the information processing system 100.

### <Step S103>

For the information processing system 100, which is the transmission source of the connection request signal, the control portion 25 of the image processing system 200 generates connection information necessary for connection with the image processing system 200 and transmits the generated connection information to the information processing system 100. Here, the connection information includes a uniform resource locator (URL) indicating a storage location of function information (in this case, an XSD file).

### <Step S104>

The control portion 10 of the information processing system 100 receives the connection information from the image processing system 200.

### <Step S105>

The control portion 10 of the information processing system 100 accesses the URL included in the received connection information. The control portion 10 thereby requests the image processing system 200 to transmit the function information.

### <Step S106>

Upon receiving the transmission request from the information processing system 100, the control portion 25 of the image processing system 200 reads the function information stored in the ROM 252 or the secondary storage device 254 in advance, and transmits the read function information to the information processing system 100.

### <Step S107>

The control portion 10 of the information processing system 100 receives the function information from the image processing system 200. The acquisition portion 104 of the control portion 10 thereby acquires the function information.

### <Step S108>

The control portion 10 of the information processing system 100 parses the acquired function information (in this case, the XSD file), and dynamically changes the content of the setting screen P1 based on the result of the parsing. That is, the display control portion 105 of the control portion 10 causes the display portion 11 to display the setting screen P1 including first setting items and restricting the display of second setting items based on the acquired function information.

As described above, in the information processing system 100 according to the present embodiment, the setting screen P1 restricting the display of second setting items relating to jobs not executable by the image processing system 200 is displayed on the display portion 11. Therefore, when the user sets a job for the image processing system 200 while viewing the setting screen P1, the user cannot set the second setting items. For example, in the example shown in <Pattern 2> of FIG. 6, since “post-processing” which is a second setting item is not displayed on the setting screen P1, the user cannot set “post-processing”. Therefore, the information processing system 100 according to the present embodiment has an advantage of being able to prevent transmission of an instruction to execute a job not executable by the image processing system 200. This prevents non-executable jobs from being transmitted to the image processing system 200, eliminating the need for the user to reset a job executable by the image processing system 200, thereby improving user convenience.

By the way, in the present embodiment, the display control portion 105 can execute second display control processing to be described below, in addition to the first display control processing described above. In the second display control processing, unlike the first display control processing, it is assumed that there are a plurality of first setting items relating to jobs executable the image processing system 200. In addition, in the second display control processing, the display control portion 105 determines, based on the function information acquired by the acquisition portion 104, whether or not a specific combination of setting values not executable by the image processing system 200 among the setting values of the plurality of first setting items has been input. When it is determined that the specific combination of setting values has been input, the display control portion 105 notifies that the job cannot be executed with the specific combination of setting values.

In other words, there is a case where the image processing system 200 can execute a job when the setting value of the first setting item is set alone, but the image processing system 200 cannot execute the job depending on the combination of setting values of two or more first setting items. In the second display control processing, in such a case, the user is notified that the job cannot be executed with that combination.

For example, the image processing system 200 may not be able to execute the job depending on the combination of the setting value of the sheet size of the sheet Sh1 and the setting value of the sheet discharge destination of the sheet Sh1 after image formation. That is, depending on the size of the designated discharge tray 51, the sheet Sh1 after image formation may not fit entirely into the discharge tray even if it is conveyed thereto.

In addition, for example, there is a case where the image processing system 200 cannot execute a job depending on the combination of setting value of the type of post-processing and the setting value of the sheet size of the sheet Sh1. That is, when the type of post-processing is the folding process and the sheet size of the sheet Sh1 is out of the range that enables the folding process, the folding process may not be performed on the sheet Sh1. In addition, for example, there is a case where the image processing system 200 cannot execute a job depending on the combination of the setting value of the type of post-processing and the setting value of the sheet type of the sheet Sh1. That is, when the type of post-processing is the folding process and the type of the sheet Sh1 is a relatively thick sheet, the folding process may not be executed on the sheet Sh1. It is noted that, when the type of post-processing is the binding process or punching process, there may also be a combination with which the image processing system 200 cannot execute the job, as in the above case.

The specific combination of setting values as described above is included in the function information. In the present embodiment, the specific combination of setting values is described in the XSD file. Every time the user changes the setting value of any of the first setting items on the setting screen P1, the display control portion 105 determines whether or not the specific combination of setting values has been input, by referring to the function information. When it is determined that the specific combination of setting values has been input, the display control portion 105 notifies the user that the job cannot be executed with the specific combination of setting values.

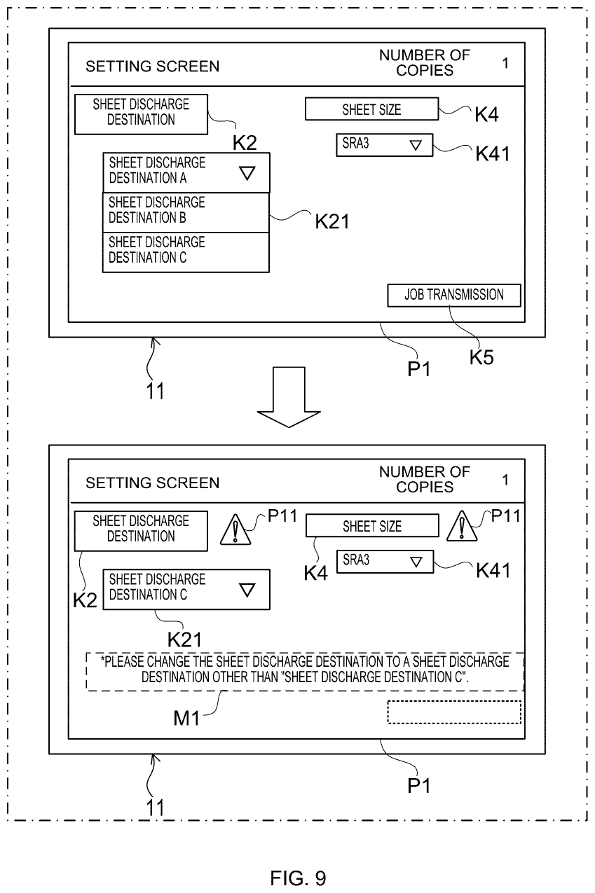

Hereinafter, a specific example of the second display control processing will be described with reference to FIG. 9. In the example shown in FIG. 9, as shown in the upper part of FIG. 9, the operation key K2 of “sheet discharge destination”, which is a first setting item, the operation key K4 of “sheet size”, which is a first setting item, and the operation key K5 of “job transmission” are displayed on the setting screen P1. Further, “sheet discharge destination A”, “sheet discharge destination B”, and “sheet discharge destination C” are displayed as options K21 of “sheet discharge destination”, and “SRA3” is displayed as an option K41 of “sheet size”. Here, shown is s situation where the user has already set the “sheet size” to “SRA3”, and is now attempting to set the “sheet discharge destination” to “sheet discharge destination C”.

Then, the display control portion 105 determines whether or not the combination of “sheet discharge destination C”, which is the setting value of “sheet discharge destination”, and “SRA3”, which is the setting value of “sheet size”, is included in the function information acquired by the acquisition portion 104. Here, it is assumed that the combination of setting values is included in the function information. Then, as shown in the lower part of FIG. 9, the display control portion 105 displays a notification image P11 representing an exclamation mark next to the “sheet discharge destination” and next to the “sheet size”. The display control portion 105 thereby notifies that the image processing system 200 cannot execute the job with the above-described combination of setting values.

According to the second display control processing, the user can recognize that the image processing system 200 cannot execute the job with the combination of setting values, which provides an advantage of making it easier to prevent the transmission of instructions to execute jobs not executable by the image processing system 200. This prevents non-executable jobs from being transmitted to the image processing system 200, eliminating the need for the user to reset a job executable by the image processing system 200, thereby improving user convenience.

It is noted that the notification image P11 does not have to be displayed in the vicinity of each of the one or more target first setting items (in this case, “sheet discharge destination” and “sheet size”), and may be displayed in the vicinity of any one of the first setting items. In addition, the notification image P11 is not limited to the exclamation mark, and may be any mode capable of alerting the user that the job cannot be executed.

In addition, in the example shown in FIG. 9, the display control portion 105 causes the display portion 11 to display the notification image P11 and hide the operation key K5 of “job transmission”, as shown in the lower part of FIG. 9. That is, when the display control portion 105 determines that the specific combination of setting values has been input, the display control portion 105 causes the display portion 11 to display the setting screen P1 restricting the display of the item (here, “job transmission”) for instructing the execution of the job is restricted. Thus, since the user cannot transmit the instruction to execute the job, the transmission of instructions to execute jobs not executable by the image processing system 200 can be more reliably prevented.

It is noted that, in the example shown in FIG. 9, the display control portion 105 restricts the display of the item (in this case, “job transmission”) for instructing the execution of the job by not causing the item to be displayed on the setting screen P1. For example, the display control portion 105 may restrict the display of the item by causing the item displayed in a grayed-out state on the setting screen P1. As described above, the display of the item only has to be restricted on the setting screen P1 in such a manner that the user cannot input the item.

In addition, in the example shown in FIG. 9, the display control portion 105 causes the display portion 11 to display the notification image P11 and also display a message M1 “Please change the sheet discharge destination to a sheet discharge destination other than ‘sheet discharge destination C’”, as shown in the lower part of FIG. 9. In other words, the display control portion 105 issues a notification prompting change of one or more setting values (in this case, the setting value of “sheet discharge destination”) of the specific combination of setting values. This makes it easier for the user to change the specific combination of setting values to a combination of setting values that allows the image processing system 200 to execute the job, thereby improving user convenience.

It is noted that, in the example shown in FIG. 9, when it is determined that the specific combination of setting values has been input, the display control portion 105 notifies that the job cannot be executed with the specific combination of setting values; however, the embodiment is not limited thereto. For example, the display control portion 105 may cause, based on the function information, the display portion 11 to display the setting screen P1 restricting the display of the specific combination of setting values not executable by the image processing system 200 among the setting values of the plurality of first setting items. That is, the display control portion 105 restricts the display of the specific combination of setting values on the setting screen P1 so as not to allow the user to input the specific combination of setting values from the beginning.

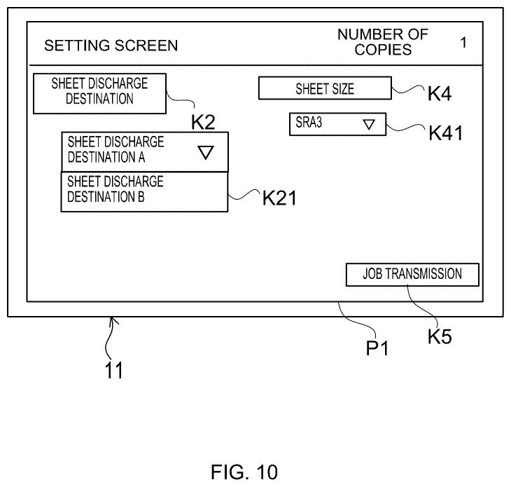

Hereinafter, a specific example of restricting the display of a specific combination of setting values will be described with reference to FIG. 10. In the example shown in FIG. 10, similarly to the example shown in FIG. 9, an operation key K2 of “sheet discharge destination”, which is a first setting item, an operation key K4 of “sheet size”, which is a first setting item, and an operation key K5 of “job transmission” are displayed on the setting screen P1. Here, a situation where the user has set the “sheet size” to “SRA3” is shown.

When “sheet size” is set to “SRA3”, the display control portion 105 determines whether or not there is a specific combination including “SRA3”. Here, the combination of “SRA3” of the “sheet size” and “sheet discharge destination C” of the “sheet discharge destination” corresponds to the specific combination of setting values. Then, the display control portion 105 restricts the display of the specific combination of setting values by hiding the “sheet discharge destination C” in the options K21 of “sheet destination”.

According to the above-described processing, since the user cannot input a specific combination of setting values, there is an advantage that transmission of instructions to execute jobs not executable by the image processing system 200 can be more reliably prevented.

It is noted that, in the example shown in FIG. 10, the display control portion 105 refrains from causing the specific combination of setting values to be displayed on the setting screen P1 to restrict the display of the combination, but the embodiment is not limited thereto. For example, the display control portion 105 may restrict the display of the combination by causing the combination to be displayed in a gray-out state on the setting screen P1. As described above, the display of the combination only has to be restricted on the setting screen P1 in such a manner that the user cannot input the combination.

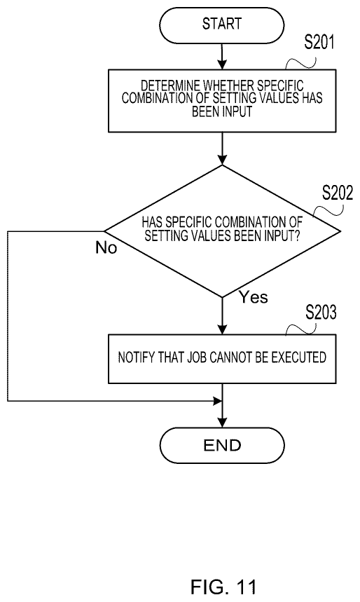

Hereinafter, an example of the information processing method of the present embodiment will be described with reference to FIG. 11, together with an example of a procedure of the second display control processing executed by the information processing system 100. Here, steps S201, S202, . . . represent the numbers of the processing procedure (steps) executed by the information processing system 100. The processing is executed, for example, when the user inputs a setting value in any of the first setting items on the setting screen P1.

### <Step S201>

First, the display control portion 105 of the information processing system 100 determines whether or not a specific combination of setting values has been input by referring to the function information acquired by the acquisition portion 104. Specifically, the display control portion 105 determines whether there is a specific combination of setting values including the input setting value of the first setting item among all specific combinations of setting values described in the function information.

### <Step S202>

When it is determined that the specific combination of setting values has been input (step S202: Yes), the display control portion 105 executes step S203. On the other hand, when it is determined that the specific combination of setting values is not input (step S202: No), the display control portion 105 does not execute step S203.

### <Step S203>

The display control portion 105 notifies that the job cannot be executed by the image processing system 200 with the specific combination of setting values including the input setting value. Here, the display control portion 105 issues the above notification by causing the notification image P11 to be displayed in the vicinity of one or more first setting items included in the combination on the setting screen P1. It is noted that the display control portion 105 may further display a message M1 that prompts the user to change the setting value, or may restrict the display of the item for instructing the execution of the job.

### Modifications

In the present embodiment, the display control portion 105 issues the notification prompting change of one or more setting values of the specific combination of setting values in the second display control processing, but the notification does not have to be issued. In addition, in the present embodiment, the display control portion 105 executes the processing of restricting the display of the item for instructing the execution of the job in the second display control processing.

In the present embodiment, the display control portion 105 is able to execute both the first display control processing and the second display control processing, but may be able to execute only the first display control processing.

In the present embodiment, the information processing system 100 includes the control portion 10 and the display portion 11, but the configuration is not limited thereto. The information processing system 100 may include at least the acquisition portion 104 and the display control portion 105 of the control portion 10.

In the present embodiment, the information processing system 100 is configured such that the components such as the acquisition portion 104 and the display control portion 105 are accommodated in a single housing, but may be configured such that the components are separately accommodated in a plurality of housings.

### APPENDIXES TO DISCLOSURE

The following are appendixes to the overview of the disclosure extracted from the above embodiment. It is noted that the structures and processing functions to be described in the following appendixes can be selected and combined arbitrarily.

### Appendix 1

An information processing system comprising:
an acquisition portion configured to communicate with an image processing system capable of executing image forming processing for forming an image on a sheet based on image data to acquire function information indicating a function of the image processing system; and
a display control portion configured to cause, based on the function information, a display portion to display a setting screen including a first setting item relating to a job executable by the image processing system and restricting display of a second setting item relating to a job not executable by the image processing system.

### Appendix 2

The information processing system according to Appendix 1, wherein
the first setting item includes a plurality of first setting items, and
the display control portion determines whether or not a specific combination of setting values not executable by the image processing system among setting values of the plurality of first setting items has been input based on the function information, and notifies that the job is not executable with the specific combination of setting values when it is determined that the specific combination of setting values has been input.

### Appendix 3

The information processing system according to Appendix 2, wherein, when it is determined that the specific combination of setting values has been input, the display control portion causes the display portion to display the setting screen in which display of an item for instructing execution of the job is restricted.

### Appendix 4

The information processing system according to Appendix 2 or 3, wherein the display control portion issues a notification prompting change of at least one setting value of the specific combination of setting values.

### Appendix 5

The information processing system according to Appendix 1, wherein
the first setting item includes a plurality of first setting items, and
the display control portion causes, based on the function information, the display portion to display the setting screen in which display of a specific combination of setting values not executable by the image processing system among setting values of the plurality of first setting items is restricted.

### Appendix 6

An image processing system comprising:
a reception processing portion configured to communicate with the information processing system according to any one of Appendixes 1 to 5 to receive a transmission request for the function information from the information processing system; and
   a transmission processing portion configured to transmit the function information to the information processing system.

### Appendix 7

An information processing method executed by one or more processors, the method comprising:
communicating with an image processing system capable of executing image forming processing for forming an image on a sheet based on image data to acquire function information indicating a function of the image processing system; and
   causing, based on the function information, a display portion to display a setting screen including a first setting item relating to a job executable by the image processing system and restricting display of a second setting item relating to a job not executable by the image processing system.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing system comprising:
an acquisition portion configured to communicate with an image processing system capable of executing image forming processing for forming an image on a sheet based on image data to acquire function information indicating a function of the image processing system; and
a display control portion configured to cause, based on the function information, a display portion to display a setting screen including a first setting item relating to a job executable by the image processing system and restricting display of a second setting item relating to a job not executable by the image processing system.

2. The information processing system according to claim 1, wherein
the first setting item includes a plurality of first setting items, and
the display control portion determines whether or not a specific combination of setting values not executable by the image processing system among setting values of the plurality of first setting items has been input based on the function information, and notifies that the job is not executable with the specific combination of setting values when it is determined that the specific combination of setting values has been input.

3. The information processing system according to claim 2, wherein, when it is determined that the specific combination of setting values has been input, the display control portion causes the display portion to display the setting screen in which display of an item for instructing execution of the job is restricted.

4. The information processing system according to claim 2, wherein the display control portion issues a notification prompting change of at least one setting value of the specific combination of setting values.

5. The information processing system according to claim 1, wherein
the first setting item includes a plurality of first setting items, and
the display control portion causes, based on the function information, the display portion to display the setting screen in which display of a specific combination of setting values not executable by the image processing system among setting values of the plurality of first setting items is restricted.

6. An image processing system comprising:
a reception processing portion configured to communicate with the information processing system according to claim 1 to receive a transmission request for the function information from the information processing system; and
a transmission processing portion configured to transmit the function information to the information processing system.

7. An information processing method executed by one or more processors, the method comprising:
communicating with an image processing system capable of executing image forming processing for forming an image on a sheet based on image data to acquire function information indicating a function of the image processing system; and
causing, based on the function information, a display portion to display a setting screen including a first setting item relating to a job executable by the image processing system and restricting display of a second setting item relating to a job not executable by the image processing system.
